(19) United States
(12) Patent Application Publication
(10) Pub. No.: US 2016/0370880 A1
(43) Pub. Date: Dec. 22, 2016

(54) OPTICAL INPUT METHOD AND OPTICAL VIRTUAL MOUSE UTILIZING THE SAME

(71) Applicant: Quanta Computer Inc., Taoyuan City (TW)

(72) Inventors: Yun-Cheng LIU, Taoyuan City (TW); Chin-Kang CHANG, Taoyuan City (TW); Chao-Ching HUANG, Taoyuan City (TW)

(21) Appl. No.: 14/828,831

(22) Filed: Aug. 18, 2015

(30) Foreign Application Priority Data
Jun. 22, 2015 (TW) 104119929

(51) Int. Cl. G06F 3/03; G06T 7/60; G06T 7/20; G06F 3/0354; G06F 3/038

(52) U.S. Cl. CPC G06F 3/0321; G06F 3/03543; G06F 3/0383; G06T 7/20; G06T 7/60

(57) ABSTRACT

An optical input method and an optical virtual mouse utilizing the same are provided. The optical input method, adopted by an optical virtual mouse, includes: emitting, by a light source, a first optical representation; generating, by an image sensor, a sense image which includes the first optical representation; determining, by a controller, a first distance between a first finger and the image sensor based on a first position of the first optical representation in the sense image; and determining, by the controller, a first displacement of the optical virtual mouse along a first direction according to the first distance.

### CROSS REFERENCE TO RELATED APPLICATIONS

This Application claims priority of Taiwan Patent Application No. 104119929, filed on Jun. 22, 2015, and the entirety of which is incorporated by reference herein.

### BACKGROUND OF THE INVENTION

Field of the Invention

The present invention relates to an input system, and in particular it relates to an optical input method and an optical virtual mouse utilizing the same.

Description of the Related Art

A mouse is a common computing input device which positions a cursor on a screen and operates an application on the screen via a mouse click.

An optical input method and an optical virtual mouse utilizing the same are disclosed in the invention, simulating a mouse operation with a hand and without a physical mouse device.

### BRIEF SUMMARY OF THE INVENTION

A detailed description is given in the following embodiments with reference to the accompanying drawings.

An embodiment of an optical input method is disclosed, adopted by an optical virtual mouse, including emitting, by a light source, a first optical representation; generating, by an image sensor, a sense image which includes the first optical representation; determining, by a controller, a first distance between a first finger and the image sensor based on a first position of the first optical representation in the sense image; and determining, by the controller, a first displacement of the optical virtual mouse along a first direction according to the first distance.

Another embodiment of an optical virtual mouse is described, including a light source, an image sensor, and a controller. The light source is configured to emit a first optical representation. The image sensor is configured to generate a sense image which includes the first optical representation. The controller is configured to determine a first distance between a first finger and the image sensor based on a first position of the first optical representation in the sense image, and determine a first displacement of the optical virtual mouse along a first direction according to the first distance.

### BRIEF DESCRIPTION OF THE DRAWINGS

The present invention can be more fully understood by reading the subsequent detailed description and examples with references made to the accompanying drawings, wherein:

FIG. 1 is a schematic diagram of an optical virtual mouse input system 1 according to an embodiment of the invention;

FIG. 2 is a schematic diagram of an optical mouse input system 2 according to an embodiment of the invention;

FIGS. 3A and 3B illustrate examples of an interference pattern and a 2D barcode, respectively;

FIGS. 4A, 4B, 4C and 4D are schematic diagrams illustrating perpendicular displacements of an optical virtual mouse in an optical mouse input system according to embodiments of the invention;

FIGS. 5A, 5B, 5C and 5D are schematic diagrams illustrating horizontal displacements of an optical virtual mouse in an optical mouse input system according to embodiments of the invention;

FIG. 6 is a flowchart of an optical input method 6 according to an embodiment of the invention; and

FIG. 7 is a flowchart of an optical input method 7 according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

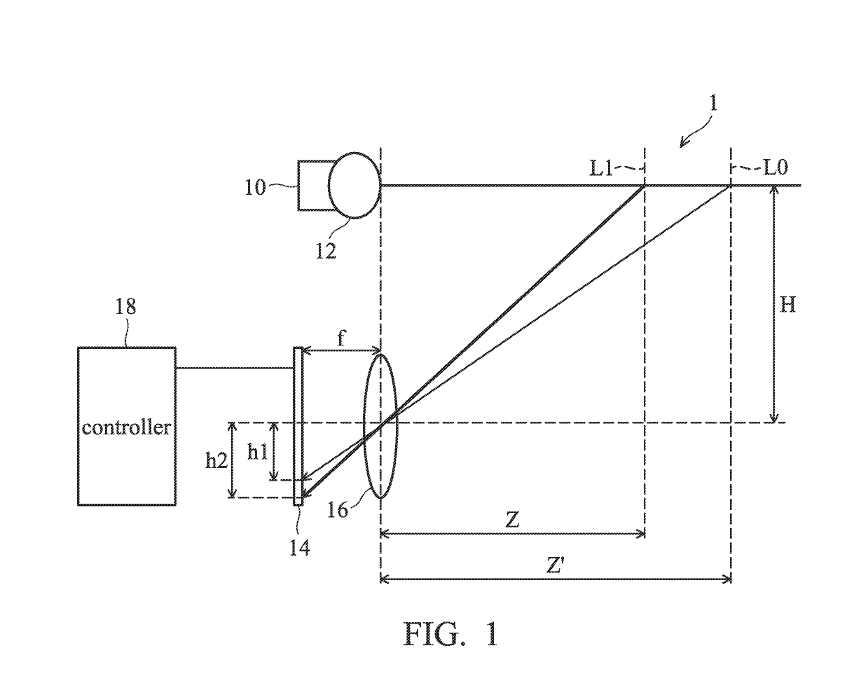

FIG. 1 is a schematic diagram of an optical virtual mouse input system 1 according to an embodiment of the invention, including a light source 10, a light diffuser 12, an image sensor 14, a lens 16, and a controller 18. When an object such as a finger enters a detection zone of the optical virtual mouse input system 1, the optical virtual mouse input system 1 may determine a distance Z′ of the object based on a location of an image projection of a specific optical representation on the image sensor 14. That is, the optical virtual mouse input system 1 may regard the object in the detection zone as an optical virtual mouse and determine a position and a displacement of the optical virtual mouse based on the change in distance Z′.

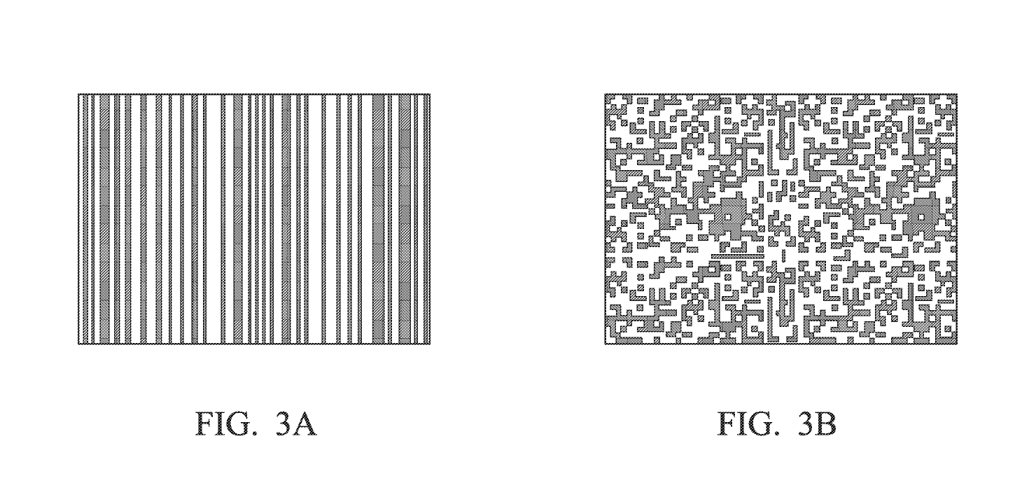

The light source 10 may generates a laser light, which is used to generate an optical representation with a specific pattern by the light diffuser 12 to be projected to an image plane. The specific pattern of the optical representation may be an interference pattern or a 2D barcode, illustrated in FIGS. 3A and 3B, respectively.

The image sensor 14 may generate a sense image by sensing the optional representation projected onto the image place via the lens, and the controller may process the sense image to compute a perpendicular distance between the image sensor 14 and the object in the detection zone of the image sensor 14, thereby determining a position and a displacement of the optical virtual mouse. In particular, the controller 18 may calculate the perpendicular distance Z′ between the object and the image sensor 14 according to Equation set (1) deduced from the geometrical relationship shown in FIG. 1.

h1/f=H/Z;

Z=f(h1);

|dZ|=|Z′−Z|=(Z2/f*H)*dh Equation set (1)

where Z is a distance from the lens 16 to a reference plane L1, and is a known number;

f is a distance from the lens 16 to the image sensor 14, and is a known number;

h1 is a position coordinate of the optical representation on the image sensor 14, wherein the optical representation is projected from the reference plane L1 positioned at a distance Z to the image sensor 14, h1 is a known number;

h2 is a position coordinate of the optical representation on the image sensor 14, wherein the optical representation is projected from a plane L2 positioned at a distance Z′ to the image sensor 14;

dh is the difference between h1 and h2; and

Z′ is the distance to be calculated.

During calibration, the system 1 may project the optical representation with the specific pattern by the light source 10 and the light diffuser 12 to the reference plane L2 to obtain the reference coordinate h1, and then during a normal operation, calculate the perpendicular distance Z1 from the object to the image sensor 14 using Equation set (1).

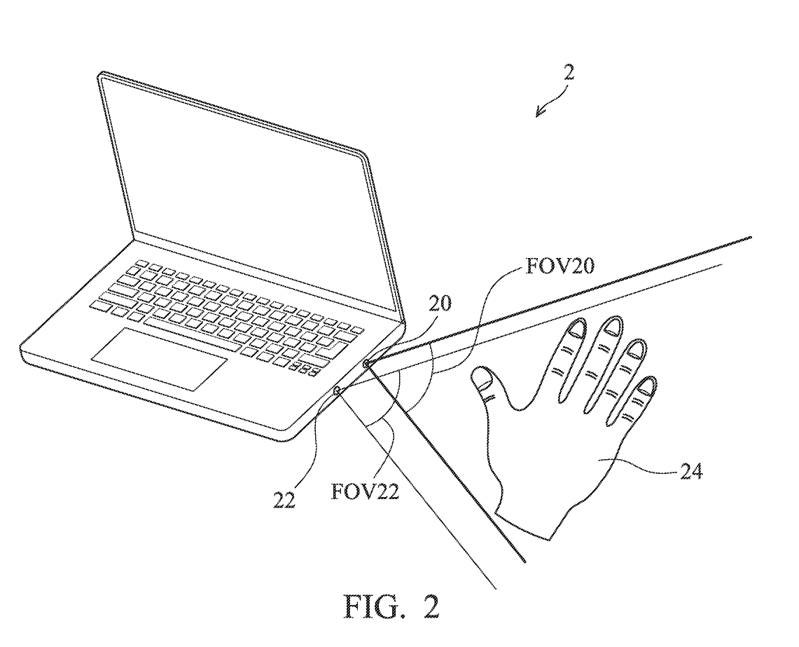

FIG. 2 is a schematic diagram of an optical mouse input system 2 according to an embodiment of the invention, adopted in a notebook computer, wherein the optical mouse input system 2 may be disposed on a side edge of a keyboard of the notebook computer, a user may use his or her hand as a virtual mouse to perform various mouse operations.

The optical mouse input system 2 include a light source and light diffuser 20 and a lens and image sensor 22, wherein the light source and light diffuser 20 has a projection zone FOV20, and the lens and image sensor 22 has a detection zone 22. When a hand 24 is placed in an overlapped zone of the projection zone FOV20 and the detection zone FOV 22, the light source and light diffuser 20 may project the optical representation onto the hand, and the lens and image sensor 22 may detect a sense image which includes the optical representation on the hand 24. An optical mouse controller (not shown) or a notebook computer processor may determine a perpendicular distance between the hand and the lens and image sensor 22 according to a pixel position of the optical representation on the hand 24 in the sense image, and determine a mouse displacement according to a change in the perpendicular distances, wherein the mouse displacement includes a perpendicular displacement (first displacement) and a horizontal displacement (second displacement). The perpendicular displacement is a displacement along a perpendicular direction (first direction) to the plane of the lens and image sensor 22, the horizontal displacement is a displacement along a horizontal direction (second direction) to the plane of the lens and image sensor 22.

Since not all fingers are laid on the same plane, the optical mouse controller may determine a corresponding perpendicular distance from the image sensor 22 to each finger according to the optical representation in the sense image. For example, the perpendicular distance of the thumb is 5 cm, the perpendicular distance of the index finger is 6 cm, and the perpendicular distance of the middle finger is 7 cm. The optical mouse controller may determine various mouse operations for the optical virtual mouse based on these perpendicular distances, including a mouse shift operation and a mouse click operation.

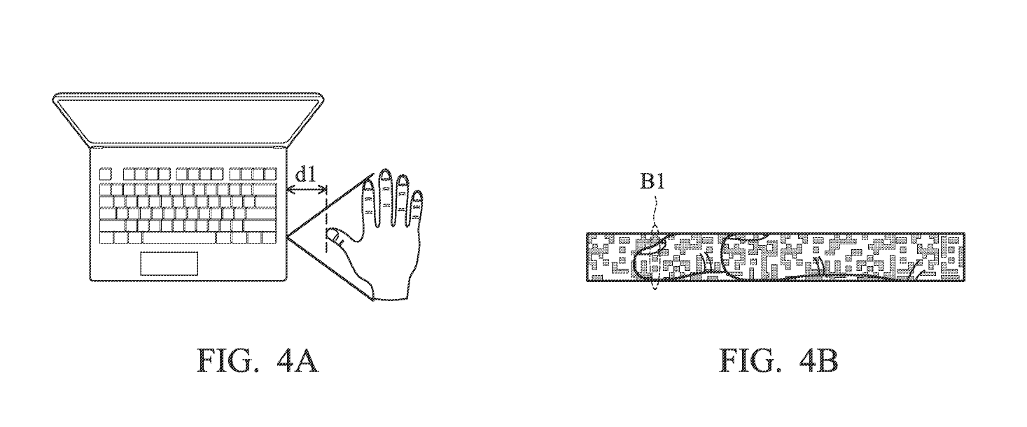

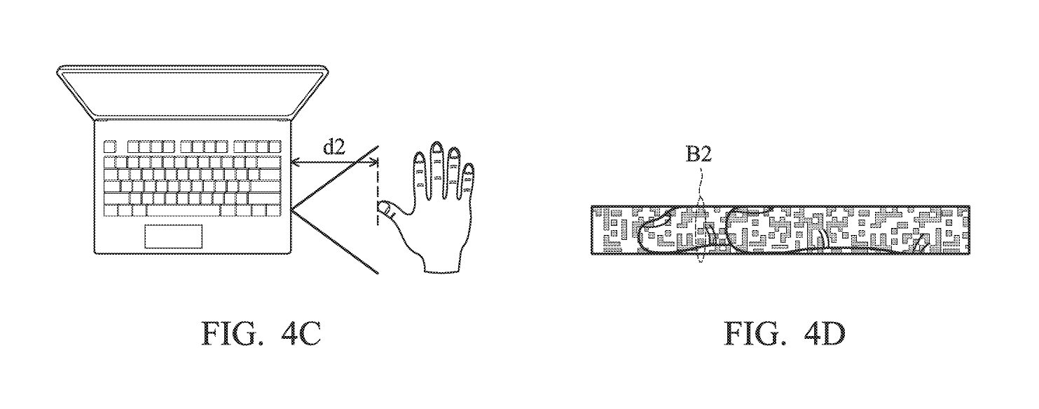

In certain embodiments, the optical mouse controller may determine the perpendicular displacement according to the change in the perpendicular distances of each finger. For example, when the perpendicular distances of the thumb, the index finger, and the middle finger vary from 5, 6, 7 cm to 6, 7, 8 cm, respectively, the optical mouse controller may determine that the optical virtual mouse is moving toward the right; whereas when the index finger, and the middle finger vary from 5, 6, 7 cm to 4, 5, 6 cm, respectively, the optical mouse controller may determine that the optical virtual mouse is moving toward the left. FIGS. 4A, 4B, 4C and 4D illustrate embodiments for how the optical mouse input system determines the perpendicular displacements.

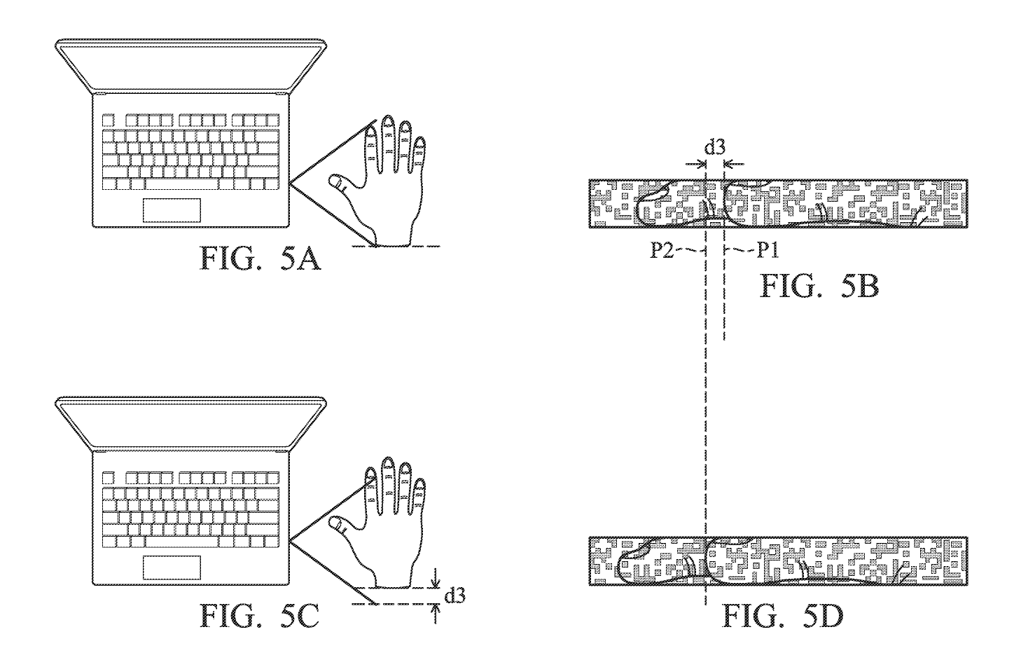

In certain embodiments, the optical mouse controller may determine a feature based on the difference between the perpendicular distances of different fingers, and determine the horizontal displacement of the mouse according to the horizontal displacement of the features in the sense images. For example, when the perpendicular distances of the thumb, the index finger, and the middle finger are 5, 6, and 7 cm respectively, the optical mouse controller may determine that features occur at where the perpendicular distances change from 7 cm to 6 cm and from 6 cm to 5 cm. When the features shift 1 cm to the left edge of the sense image, the optical mouse controller may determine that the mouse is moving upward; whereas when the features shift 1 cm to the right edge of the sense image, the optical mouse controller may determine that the mouse is moving downward. FIGS. 5A, 5B, 5C and 5D illustrate embodiments for how the optical mouse input system determines the horizontal displacements.

In some embodiments, the optical mouse controller may determine the mouse click operation according to the perpendicular distances between the fingers. When the difference between the perpendicular distances of the fingers is within a predetermined distance difference range (second predetermined finger-width range), the optical mouse controller may determine that the mouse click operation has occurred. For example, when a user lifts his/her index finger to simulate a left mouse click operation, the optical mouse controller may determine that the perpendicular distances of the thumb and the middle finger are 5 cm and 7.5 cm, respectively, and the difference between the perpendicular distances of the thumb and the middle finger is 2.5 cm, within a predetermined distance difference range of 1.5 cm-3 cm, thus the optical mouse controller may determine that the user is simulating the mouse click operation.

FIGS. 4A, 4B, 4C and 4D are schematic diagrams illustrating perpendicular displacements of an optical virtual mouse in an optical mouse input system according to embodiments of the invention.

Firstly please refer to FIGS. 4A and 4C, where the optical mouse system is disposed at the right edge of a notebook computer keyboard, and the user may move his/her hand to the left or right to simulate a left or right movement of an optical virtual mouse. FIG. 4A shows that the user moves his/her hand to the left, and a distance between a thumb and the optical mouse system is a distance dl; and FIG. 4C shows that the user moves his/her hand to the right, and the distance between a thumb and the optical mouse system is a distance d2, wherein the distance d2 exceeds the distance d1.

When the hand enters a certain distance from an image sensor of the optical mouse system, the image sensor may produce sense images as in FIGS. 4B and 4D, and then a controller may calculate depth distances of the hand during a left or right movement according to positions of a 2D barcode. FIG. 4B shows the 2D barcode image when the hand moves to the left and closer from the image sensor, and FIG. 4D shows the 2D barcode image when the hand moves to the right and further from the image sensor. The controller may determine the perpendicular distance from the hand to the image sensor according to the corresponding barcode positions B1 and B2, thereby determining the left and right displacement of the optical virtual mouse according to the change in the perpendicular distances.

FIGS. 5A, 5B, 5C and 5D are schematic diagrams illustrating horizontal displacements of an optical virtual mouse in an optical mouse input system according to embodiments of the invention.

Firstly please refer to FIGS. 5A and 5C, where the optical mouse system is disposed at the right edge of a notebook computer keyboard, and the user may move his/her hand up or down to simulate a up or down movement of an optical virtual mouse. FIG. 5A shows that the user's hand remains still; and FIG. 5C shows that the user moves his/her hand downwards, and a distance of the movement is a distance d3.

When the hand enters a certain distance from an image sensor of the optical mouse system, the image sensor may produce sense images as in FIGS. 5B and 5D, and then a controller may calculate a depth distance of each finger, determine a feature according to the depth distance (perpendicular distance) of each finger, and determine the horizontal displacement of the optical virtual mouse according to the feature. For example, FIG. 5B shows a thumb right from a position P1 has a perpendicular distance of 3 cm and an index finger left from the position P1 has a perpendicular distance of 4 cm, thus the controller may determine the conjuncture position P1 between the 3 cm and 4 cm perpendicular distances as a feature. Likewise, FIG. 5D shows a thumb right from a position P2 has a perpendicular distance of 3 cm and an index finger left from the position P2 has a perpendicular distance of 4 cm, thus the controller may determine the conjuncture position P2 between the 3 cm and 4 cm perpendicular distances as a feature. When comparing the features in FIGS. 5B and 5D, the controller may determine a displacement of the feature, or a pixel difference between the positions P1 and P2 is the distance d3, thus the distance d3 is determined as the downward displacement of the optical virtual mouse.

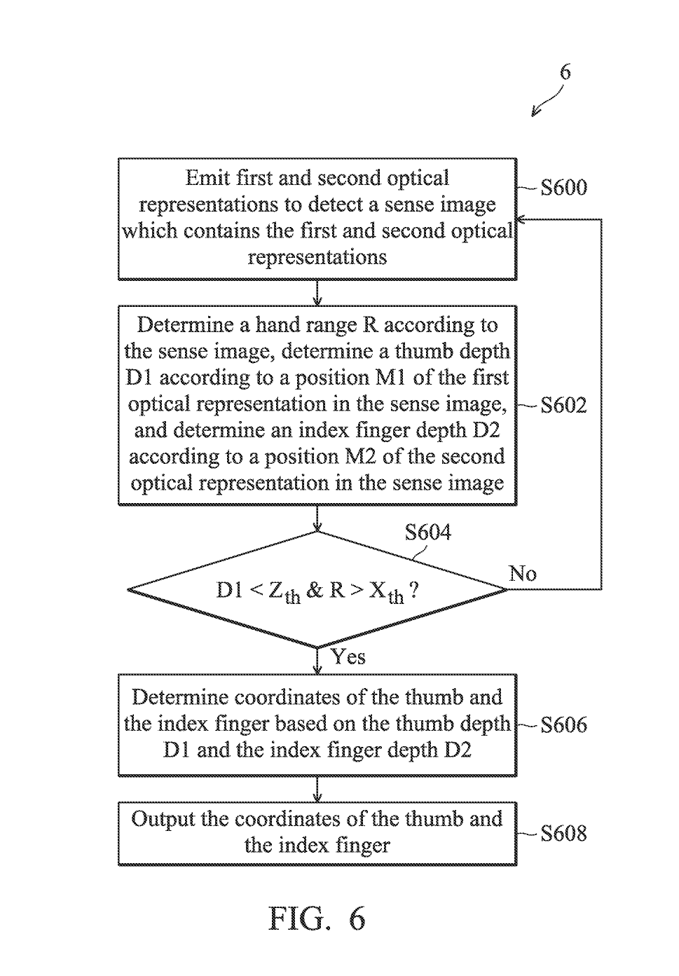

FIG. 6 is a flowchart of an optical input method 6 according to an embodiment of the invention, incorporating the optical mouse input system 1 in FIG. 1. The optical mouse input system 1 may be disposed at the keyboard edge of a notebook computer to detect the movement of a hand for simulating an optical virtual mouse operation. The optical input method 6 may be implemented by hardware circuits, software codes executable by the controller, or a combination thereof. The optical input method 6 may be initiated upon power-up or when an optical input function is initiated.

Upon start-up, the light source 10 and the light diffuser 12 may emit first and second optical representations to generate the sense images by the lens 16 and the image sensor 14, where the sense image includes the first and second optical representations (S600). The first and second optical representations may be a part of the interference pattern or the 2D barcode in FIGS. 3A or 3B. The image sensor 14 may transmit the sense image to the controller 18 to determine whether the hand is in the detection zone and determine the optical mouse operation. The optical mouse operation includes a mouse shift operation and a mouse click operation.

The controller 18 may determine a hand range R according to the sense image, determine a thumb depth D1 (a perpendicular distance from the thumb to the image sensor) according to a position M1 of the first optical representation in the sense image, and determine an index finger depth D2 (a perpendicular distance from the index finger to the image sensor) according to a position M2 of the second optical representation in the sense image (S602).

Next, the controller 18 may determine a size R of the thumb or the hand based in the sense image, e.g., the size R of the hand is 15 cm or the size R of the thumb is 7 cm. Then the controller 18 may determine that whether the thumb depth D1 is less than a predetermined distance Zth and the hand or thumb range R exceeds a predetermined size Xth (S604). When the thumb depth D1 is less than the predetermined distance Zth, this indicates that the hand is close to the image sensor 14, ready to perform a mouse operation. When the hand or thumb range R exceeds a predetermined size Xth, this indicates that most of the hand has entered the detection zone of the image sensor 14. Only when both of the conditions are valid may the controller 18 continue to determine the virtual mouse operation in Step S606. Otherwise the optical input method 6 may return to Step S600 to sense the sense image again.

In Step S606, the controller 18 may determine the perpendicular displacements and horizontal displacements of the thumb and the index finger based on the thumb depth D1 and the index finger depth D2 using the displacement determination methods of the optical virtual mouse disclosed in the FIGS. 4A, 4B, 4C, 4D and FIGS. 5A, 5B, 5C, 5D, thereby calculating the coordinates of the thumb and the index finger.

Finally, the controller 18 may output the coordinates of the thumb and the index finger to the notebook computer to display the corresponding mouse position on the computer screen or executing the corresponding application operation (S608).

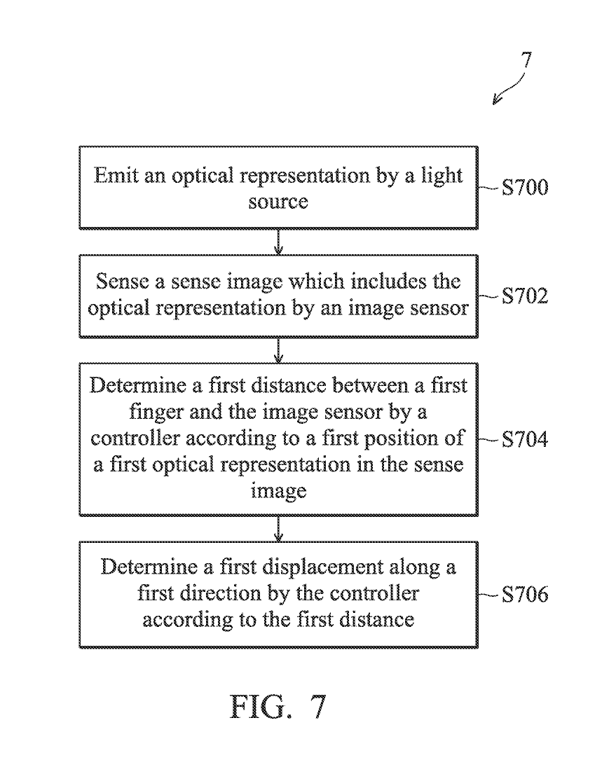

FIG. 7 is a flowchart of an optical input method 7 according to another embodiment of the invention, incorporating the optical mouse input system 1 in FIG. 1. The optical mouse input system 1 may be disposed at the keyboard edge of a notebook computer to detect the movement of a hand for simulating an optical virtual mouse operation. The optical input method 7 may be implemented by hardware circuits, software codes executable by the controller, or a combination thereof, and may be initiated upon power-up or when an optical input function is initiated.

Upon start-up the light source 10 and the light diffuser 12 may emit an optical representation (S700) to generate the sense images by the lens 16 and the image sensor 14 (S702), where the sense image includes the optical representation. The first and second optical representations may be a part of the interference pattern or the 2D barcode in FIGS. 3A or 3B. The image sensor 14 may transmit the sense image to the controller 18 to determine whether the hand is in the detection zone and determine the optical mouse operation. The optical mouse operation includes a mouse shift operation and a mouse click operation.

Next, when the hand enters into the detection zone, the controller 18 may determine a first distance between a first finger and the image sensor 14 using Equation set (1) based on a first position of the first optical representation in the sense image (S704), and determine a first displacement of the optical virtual mouse along a first direction according to the first distance (S706). The first finger may be a finger closest to the image sensor 14, such as a thumb. The first direction may be a perpendicular direction from the thumb to the plane of the image sensor 14, and the first displacement may be a perpendicular displacement of the thumb. The controller 18 may determine a perpendicular displacement of the optical virtual mouse according to the perpendicular displacement of the thumb, and display a cursor on the screen or operate an active application according to the perpendicular displacement.

In certain embodiments, the controller 18 may determine a second distance between a second finger and the image sensor based on a second position of the optical representation in the sense image, and determine a second displacement of the optical virtual mouse along a second direction according to the first distance and the second distance. The second finger may be a finger second closest to the image sensor 14, such as an index finger. The second direction may be a horizontal direction from the finger to the plane of the image sensor 14, and the second displacement may be a horizontal displacement of the finger. In particular, when a depth difference between the first distance and the second distance is within a first predetermined finger-width range, the controller 18 may determine a juncture between the first distance and the second distance as a feature, and determine the second displacement of the optical virtual mouse along the second direction according to the horizontal displacement of the feature in the sense image. In one example, the first distance to the thumb is 5 cm, the second distance to the index finger is 6 cm, the first predetermined finger-width range is 0.8 cm to 1.5 cm. Since a depth difference between the first distance and the second distance is 1 cm, which is within the first predetermined finger-width range of 0.8 cm and 1.5 cm, consequently the controller 18 may determine the conjuncture between the first distance and the second distance as the feature, and determine the second displacement of the optical virtual mouse along the second direction based on the horizontal displacement of the feature in the sense image.

In certain embodiments, the controller 18 may determine the size of the first finger according to the sense image, and only when the first distance is less than a predetermined distance and the size of the first finger exceeds a predetermined size, the controller 18 may determine the second displacement of the optical virtual mouse along the second direction according to the horizontal displacement of the feature in the sense image. In one example, the size of the thumb in the sense image is 9 cm, the first distance is 4 cm, the predetermined size is 7 cm, and the predetermined distance is 5 cm. Since 9 cm of the size of the thumb exceeds 7 cm of the predetermined size and 4 cm of the first distance is less than 5 cm of the predetermined distance, the controller 18 may determine the first displacement of the optical virtual mouse along the first direction according to the first distance, and determine the second displacement of the optical virtual mouse along the second direction according to the horizontal displacement of the feature on the sense image.

In some embodiments, the controller 18 may determine mouse coordinates according to the calculated first and second displacements and display the optical virtual mouse on the screen according to the mouse coordinates.

In some embodiments, when the depth difference between the first distance and the second distance is within a second predetermined finger-width range, the controller 18 may determine that the optical virtual mouse performs a mouse click operation. A second maximal value and a second minimal value of the second predetermined finger-width range exceed a first maximal value and a first minimal value of the first predetermined finger-width range, respectively. For example, the distance to the thumb is 5 cm, the distance to the index finger is 6 cm, the distance to the middle finger is 7 cm, and the second predetermined finger-width range is 1.5 cm to 3 cm. When the index finger lifts up to simulate a mouse click operation, the controller 18 may determine that the 5 cm distance to the thumb as the first distance and the 7 cm distance to the middle finger as the second distance. Since the depth difference between the first distance and the second distance is 2 cm, within the 1.5 cm to 3 cm of the second predetermined finger-width range, thus the controller 18 may determine that the optical virtual mouse is performing a mouse click operation.

The optical input methods and the optical virtual mouse system in FIGS. 1 through 7 utilize a hand to simulate the operations of a mouse, obtain depth distance information of a hand, and perform various mouse operations based on the depth distance information of the hand.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, processor, microprocessor or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements

What is claimed is:

1. A optical input method, adopted by an optical virtual mouse, the method comprising:
emitting, by a light source, a first optical representation;
generating, by an image sensor, a sense image which includes the first optical representation;
determining, by a controller, a first distance between a first finger and the image sensor based on a first position of the first optical representation in the sense image; and
determining, by the controller, a first displacement of the optical virtual mouse along a first direction according to the first distance.

2. The optical input method of claim 1, further comprising:
emitting, by the light source, a second optical representation;
generating, by the image sensor, the sense image which includes the second optical representation;
determining, by the controller, a second distance between a second finger and the image sensor based on a second position of the second optical representation in the sense image;
when a depth difference between the first distance and the second distance is within a first predetermined finger-width range, determining, by the controller, a juncture between the first distance and the second distance as a feature; and
determining, by the controller, a second displacement of the optical virtual mouse along a second direction according to a horizontal displacement of the feature in the sense image;
wherein the first direction is perpendicular to the second direction.

3. The optical input method of claim 1, further comprising:
determining, by the controller, a size of the first finger according to the sense image;
wherein the step of determining, by the controller, a second displacement of the optical virtual mouse along the second direction according to the horizontal displacement of the feature in the sense image comprises: only when the first distance is less than a predetermined distance and the size of the first finger exceeds a predetermined size, determining, by the controller, the second displacement of the optical virtual mouse along the second direction according to the horizontal displacement of the feature in the sense image.

4. The optical input method of claim 2, further comprising:
determining, by the controller, a size of the first finger according to the sense image;
wherein the step of determining, by the controller, a second displacement of the optical virtual mouse along the second direction according to the horizontal displacement of the feature in the sense image comprises: only when the first distance is less than a predetermined distance and the size of the first finger exceeds a predetermined size, determining, by the controller, the second displacement of the optical virtual mouse along the second direction according to the horizontal displacement of the feature in the sense image; and
the optical input method further comprises: determining, by the controller, a mouse position of the optical virtual mouse according to the first displacement and the second displacement.

5. The optical input method of claim 2, further comprising:
when the depth difference between the first distance and the second distance is within a second predetermined finger-width range, determining, by the controller, that the optical virtual mouse performs a mouse click operation;
wherein a second maximal value and a second minimal value of the second predetermined finger-width range exceed a first maximal value and a first minimal value of the first predetermined finger-width range, respectively.

6. An optical virtual mouse, comprising:
a light source, configured to emit a first optical representation;
an image sensor, configured to generate a sense image which includes the first optical representation; and
a controller, configured to determine a first distance between a first finger and the image sensor based on a first position of the first optical representation in the sense image, and determine a first displacement of the optical virtual mouse along a first direction according to the first distance.

7. The optical virtual mouse of claim 6, wherein:
the light source is further configured to emit a second optical representation;
the image sensor is further configured to generate the sense image which includes the second optical representation;
the controller is further configured to determine a second distance between a second finger and the image sensor based on a second position of the second optical representation in the sense image;
when a depth difference between the first distance and the second distance is within a first predetermined finger-width range, the controller is further configured to determine a juncture between the first distance and the second distance as a feature; and
the controller is further configured to determine a second displacement of the optical virtual mouse along a second direction according to a horizontal displacement of the feature in the sense image;
wherein the first direction is perpendicular to the second direction.

8. The optical virtual mouse of claim 6, further comprising:
the controller is further configured to determine a size of the first finger according to the sense image; and
only when the first distance is less than a predetermined distance and the size of the first finger exceeds a predetermined size, the controller is configured to determine the second displacement of the optical virtual mouse along the second direction according to the horizontal displacement of the feature in the sense image.

9. The optical virtual mouse of claim 7, further comprising:
the controller is further configured to determine a size of the first finger according to the sense image; and
only when the first distance is less than a predetermined distance and the size of the first finger exceeds a predetermined size, the controller is configured to determine the second displacement of the optical virtual mouse along the second direction according to the horizontal displacement of the feature in the sense image; and
the controller is further configured to determine a mouse position of the optical virtual mouse according to the first displacement and the second displacement.

10. The optical virtual mouse of claim 7, further comprising:
when the depth difference between the first distance and the second distance is within a second predetermined finger-width range, the controller is further configured to determine that the optical virtual mouse performs a mouse click operation;
wherein a second maximal value and a second minimal value of the second predetermined finger-width range exceed a first maximal value and a first minimal value of the first predetermined finger-width range, respectively.
